(19) United States
(12) Patent Application Publication
(10) Pub. No.: US 2013/0194354 A1
(43) Pub. Date: Aug. 1, 2013

(54) PRESSURE REGULATION FOR INKJET PRINTER INK SUPPLY

(71) Applicants: Dwight John Petruchik, Honeoye Falls, NY (US); Daniel G. Warren, Rochester, NY (US)

(72) Inventors: Dwight John Petruchik, Honeoye Falls, NY (US); Daniel G. Warren, Rochester, NY (US)

(21) Appl. No.: 13/359,865

(22) Filed: Jan. 27, 2012

(51) Int. Cl. B41J 2/175

(52) U.S. Cl. 347/85

(57) ABSTRACT

An inkjet printing system includes an inkjet printhead including a nozzle array and an ink inlet fluidically connected to the nozzle array; a pressure regulated ink supply including: an unvented regulator chamber including: a capillary medium; and an ink outlet connected to the ink inlet of the printhead; a free ink reservoir including an ink inlet connector; and a dividing wall disposed between the regulator chamber and the free ink reservoir, the dividing wall including an ink passageway permitting ink to pass from the free ink reservoir into the regulator chamber; a carriage configured to move the printhead and the pressure regulated ink supply back and forth across a print region; a stationarily mounted main ink supply; and a flexible ink supply line connecting the main ink supply to the ink inlet connector of the free ink reservoir.

### FIELD OF THE INVENTION

The present invention relates generally to the field of ink supply to an inkjet printer, and more particularly to pressure regulation for the ink supply.

### BACKGROUND OF THE INVENTION

An inkjet printer typically includes one or more printheads and their corresponding ink supplies. A printhead includes an array of drop ejectors, each ejector consisting of an ink chamber, an ejecting actuator and a nozzle through which droplets of ink are ejected. The ejecting actuator can be one of various types, including a heater that vaporizes some of the ink in the chamber in order to propel a droplet out of the nozzle, or a piezoelectric device which changes the wall geometry of the chamber in order to generate a pressure wave that ejects a droplet. The droplets are typically directed toward paper or other recording medium in order to produce an image according to image data that is converted into electronic firing pulses for the drop ejectors as the print medium is moved relative to the printhead.

Ink is provided to the printhead through an ink inlet of the printhead. In some printers, the corresponding ink supply can be located remotely from the printhead and connected to it, or to an intermediate ink supply, for example by flexible tubing. Alternatively in other printers, an ink supply, also called an ink tank or ink reservoir, can be directly coupled to the printhead. For the case of ink tanks being mounted on the carriage of a carriage printer, the ink tank can be permanently mounted onto the printhead, so that the printhead needs to be replaced when the ink is depleted, or the ink tank can be detachably mounted onto the printhead, so that only the ink tank itself needs to be replaced when the ink tank is depleted. Carriage mounted ink tanks typically contain only enough ink for up to about several hundred prints. This is because the total mass of the carriage needs be limited, so that accelerations of the carriage at each end of the travel do not result in large forces that can shake the printer back and forth. As a result, for inkjet printers intended for high volume printing, typically larger volume main ink supplies are stationarily mounted off the carriage and are connected to the carriage-mounted printhead, or to an intermediate ink supply, by flexible tubing as mentioned above. Such ink supply configurations are often called off-axis ink supplies.

Ink must be supplied to the printhead at a proper pressure range relative to ambient pressure. If the pressure is not sufficiently negative relative to ambient pressure, ink will tend to drool out of the printhead nozzles. If the pressure is excessively negative, the ink chambers of the drop ejectors will not fill sufficiently rapidly, leading to printing misfires and degraded image quality. Additionally for off-axis ink supplies connected to the carriage-mounted printhead by flexible tubing, movement of the flexible tubing as the carriage is moved back and forth across the print region causes pressure spikes that must be regulated for proper ink ejection from the printhead. Typically, pressure regulation mechanisms for printers having off-axis ink supplies involve complex lung bags, flaps, springs or valves.

Consequently, a need exists for a simple pressure regulation mechanism that is effective in damping out pressure spikes caused by movement of the flexible tubing between the stationarily mounted main ink supply and the carriage-mounted printhead.

### SUMMARY OF THE INVENTION

The present invention is directed to overcoming one or more of the problems set forth above. Briefly summarized, according to one aspect of the invention, the invention resides in an inkjet printing system comprising: an inkjet printhead including a nozzle array and an ink inlet fluidically connected to the nozzle array; a pressure regulated ink supply including: an unvented regulator chamber including: a capillary medium; and an ink outlet connected to the ink inlet of the printhead; a free ink reservoir including an ink inlet connector; and a dividing wall disposed between the regulator chamber and the free ink reservoir, the dividing wall including an ink passageway permitting ink to pass from the free ink reservoir into the regulator chamber; a carriage configured to move the printhead and the pressure regulated ink supply back and forth across a print region; a stationarily mounted main ink supply; and a flexible ink supply line connecting the main ink supply to the ink inlet connector of the free ink reservoir.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic representation of an inkjet printer system;

FIG. 2 is a perspective of a portion of a printhead;

FIG. 3 is a perspective of a portion of a carriage printer;

FIG. 4 is a schematic side view of an exemplary paper path in a carriage printer;

FIG. 5 is a bottom perspective of a multi-chamber ink tank;

FIG. 6 is a top perspective of a multi-chamber ink tank;

FIG. 7 is a perspective of a printhead without ink tanks mounted;

FIG. 8 is a perspective of a portion of a printing system according to an embodiment of the invention;

FIG. 9 is a cut-away side view of a pressure regulated intermediate ink supply according to an embodiment of the invention;

FIG. 10 is a cut-away side view of a pressure regulated intermediate ink supply according to another embodiment of the invention;

FIG. 11 is a cut-away side view of a pressure regulated intermediate ink supply according to yet another embodiment of the invention;

FIG. 12 is a schematic front view of a portion of a printing system according to an embodiment of the invention; and

FIG. 13 is a schematic front view of a portion of a printing system according to another embodiment of the invention.

### DETAILED DESCRIPTION OF THE INVENTION

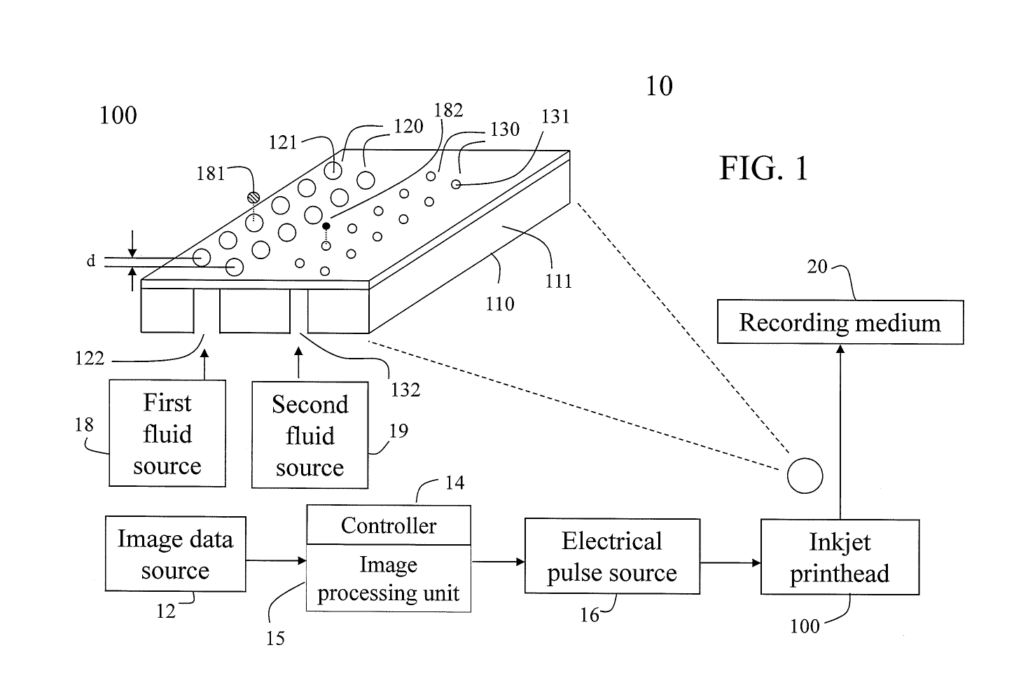

Referring to FIG. 1, a schematic representation of an inkjet printer system 10 is shown, for its usefulness with the present invention and is fully described in U.S. Pat, No. 7,350,902, and is incorporated by reference herein in its entirety. Inkjet printer system 10 includes an image data source 12, which provides data signals that are interpreted by a controller 14 as being commands to eject drops. Controller 14 includes an image processing unit 15 for rendering images for printing, and outputs signals to an electrical pulse source 16 of electrical energy pulses that are inputted to an inkjet printhead 100, which includes at least one inkjet printhead die 110.

In the example shown in FIG. 1, there are two nozzle arrays. Nozzles 121 in the first nozzle array 120 have a larger opening area than nozzles 131 in the second nozzle array 130. In this example, each of the two nozzle arrays 120, 130 has two staggered rows of nozzles 121, 131, each row having a nozzle density of 600 per inch. The effective nozzle density then in each nozzle array 120, 130 is 1200 per inch (i.e. d= 1/1200 inch in FIG. 1). If pixels on a recording medium 20 were sequentially numbered along the paper advance direction, the nozzles 121, 131 from one row of a nozzle array 120, 130 would print the odd numbered pixels, while the nozzles 121, 131 from the other row of the nozzle array 120, 130 would print the even numbered pixels.

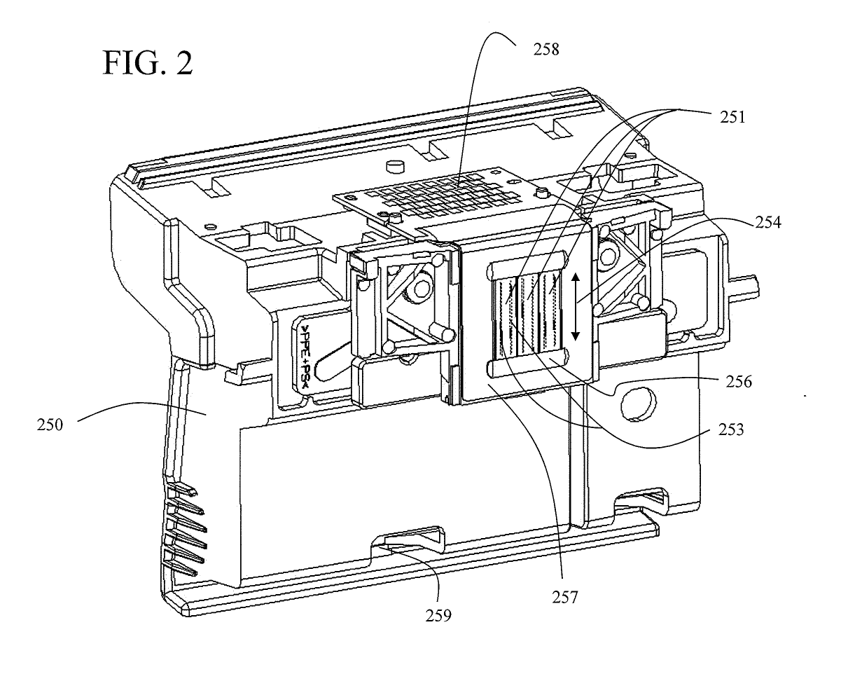

In fluid communication with each nozzle array 120, 130 is a corresponding ink delivery pathway 122. Ink delivery pathway 122 is in fluid communication with the first nozzle array 120, and an ink delivery pathway 132 is in fluid communication with the second nozzle array 130. Portions of ink delivery pathways 122 and 132 are shown in FIG. 1 as openings through a printhead die substrate 111. One or more inkjet printhead die 110 will be included in inkjet printhead 100, but for greater clarity only one inkjet printhead die 110 is shown in FIG. 1. The printhead die 110 are arranged on a support member as discussed below relative to FIG. 2. In FIG. 1, a first fluid source 18 supplies ink to first nozzle array 120 via ink delivery pathway 122, and a second fluid source 19 supplies ink to second nozzle array 130 via ink delivery pathway 132. Although distinct fluid sources 18 and 19 are shown, in some applications it can be beneficial to have a single fluid source supplying ink to both the first nozzle array 120 and the second nozzle array 130 via ink delivery pathways 122 and 132 respectively. Also, in some embodiments, fewer than two or more than two nozzle arrays 120, 130 can be included on printhead die 110. In some embodiments, all nozzles 121, 131 on inkjet printhead die 110 can be the same size, rather than having multiple sized nozzles on inkjet printhead die 110.

Not shown in FIG. 1, are the drop forming mechanisms associated with the nozzles 121, 131. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on the recording medium 20.

FIG. 2 shows a bottom perspective of a portion of a printhead 250, which is an example of the inkjet printhead 100. Printhead 250 includes three printhead die 251 (similar to printhead die 110 in FIG. 1), each printhead die 251 containing two nozzle arrays 253, so that printhead 250 contains six nozzle arrays 253 altogether. The six nozzle arrays 253 in this example can each be connected to separate ink sources (not shown in FIG. 2); such as cyan, magenta, yellow, text black, photo black, and a colorless protective printing fluid. Each of the six nozzle arrays 253 is disposed along a nozzle array direction 254, and the length of each nozzle array along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving printhead 250 across the recording medium 20. Following the printing of a swath, the recording medium 20 is advanced along a media advance direction 304 that is substantially parallel to nozzle array direction 254.

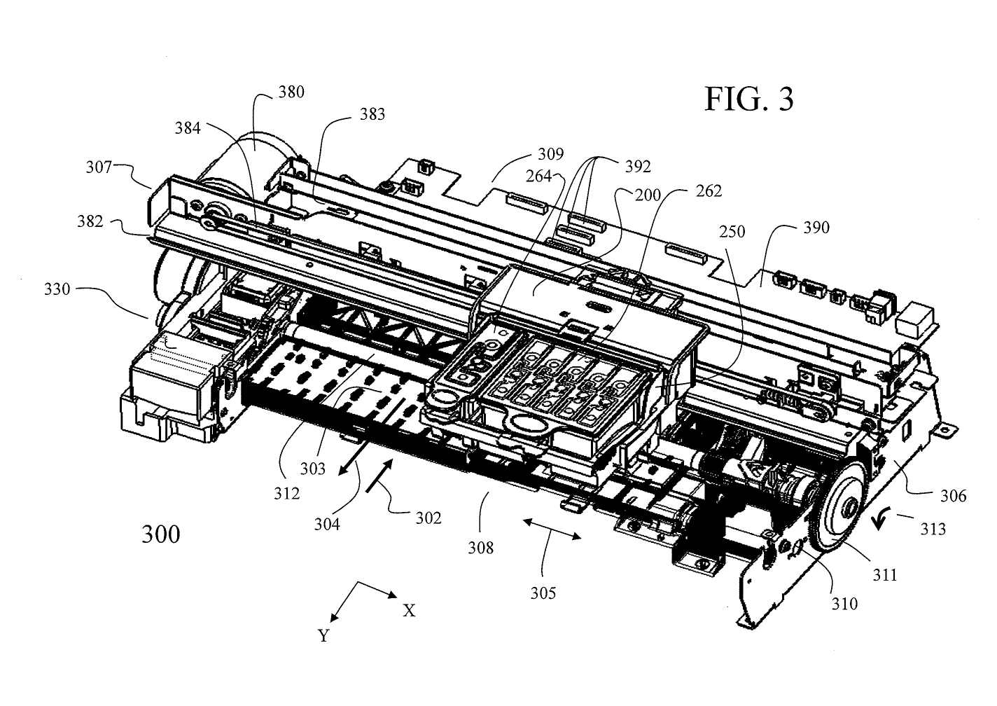

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of printhead 250 and connects to connector board 258. When printhead 250 is mounted into a carriage 200 (see FIG. 3), connector board 258 is electrically connected to a connector (not shown) on the carriage 200, so that electrical signals can be transmitted to the printhead die 251.

As described below, one or more ink tanks are detachably mountable in printhead 250. In the bottom perspective of FIG. 2, a ledge on printhead 250 is provided as a catch 259 to engage with a latch on an ink tank (not shown in FIG. 2). When catch 259 is engaged with the latch on an ink tank, the ink tank is held in its mounted position.

FIG. 3 shows a portion of a desktop carriage printer. Some of the parts of the printer have been hidden in the view shown in FIG. 3 so that other parts can be more clearly seen. Printer chassis 300 has a print region 303 across which carriage 200 is moved back and forth in a carriage scan direction 305 along the X axis, between the right side 306 and the left side 307 of printer chassis 300, while drops are ejected from printhead die 251 (not shown in FIG. 3) on printhead 250 that is mounted on carriage 200. A carriage motor 380 moves a belt 384 to move carriage 200 along carriage guide rail 382. An encoder sensor (not shown) is mounted on carriage 200 and indicates carriage location relative to an encoder fence 383.

Printhead 250 is mounted in carriage 200, and a multi-chamber ink tank 262 and a single-chamber ink tank 264 are detachably mounted in the printhead 250. The mounting orientation of printhead 250 is rotated relative to the view in FIG. 2, so that the printhead die 251 are located at the bottom side of printhead 250, the droplets of ink being ejected downward onto the recording medium in print region 303 in the view of FIG. 3. Multi-chamber ink tank 262, in this example, contains five ink sources: cyan, magenta, yellow, photo black, and colorless protective fluid; while single-chamber ink tank 264 contains the ink source for text black. Paper or other recording medium (sometimes generically referred to as paper or media herein) is loaded along a paper load entry direction 302 toward the front 308 of printer chassis 300.

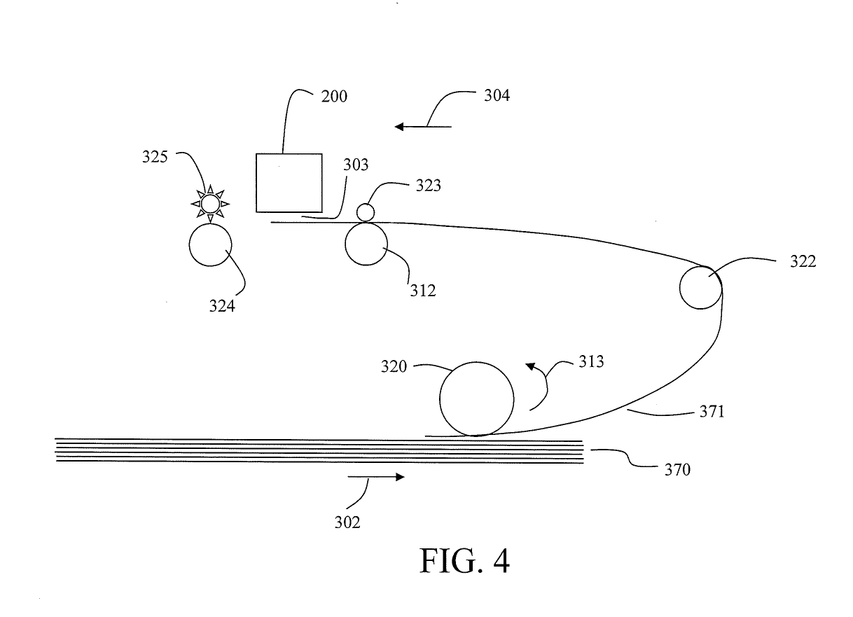

A variety of rollers are used to advance the medium through the printer as shown schematically in the side view of FIG. 4. In this example, a pick-up roller 320 moves the top piece or sheet 371 of a stack 370 of paper or other recording medium in the direction of arrow, paper load entry direction 302. A turn roller 322 acts to move the paper around a C-shaped path (in cooperation with a curved rear wall surface) so that the paper continues to advance along media advance direction 304 from the rear 309 of the printer chassis 300 (with reference also to FIG. 3). The paper is then moved by feed roller 312 and idler roller(s) 323 to advance along the Y axis across print region 303, and from there to a discharge roller 324 and star wheel(s) 325 so that printed paper exits along media advance direction 304. Feed roller 312 includes a feed roller shaft along its axis, and feed roller gear 311 is mounted on the feed roller shaft. Feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller 312.

The motor that powers the paper advance rollers is not shown in FIG. 3, but the hole 310 at the right side 306 of the printer chassis 300 is where the motor gear (not shown) protrudes through in order to engage feed roller gear 311, as well as the gear for the discharge roller (not shown). For normal paper pick-up and feeding, it is desired that all rollers rotate in forward rotation direction 313. Toward the left side 307 of the printer chassis 300, in the example of FIG. 3, is a maintenance station 330.

Toward the rear 309 of the printer chassis 300, in this example, is located an electronics board 390, which includes cable connectors 392 for communicating via cables (not shown) to the printhead carriage 200 and from there to the printhead 250. Also on electronics board 390 are typically mounted motor controllers for the carriage motor 380 and for the paper advance motor, a processor and/or other control electronics (shown schematically as controller 14 and image processing unit 15 in FIG. 1) for controlling the printing process, and an optional connector for a cable to a host computer.

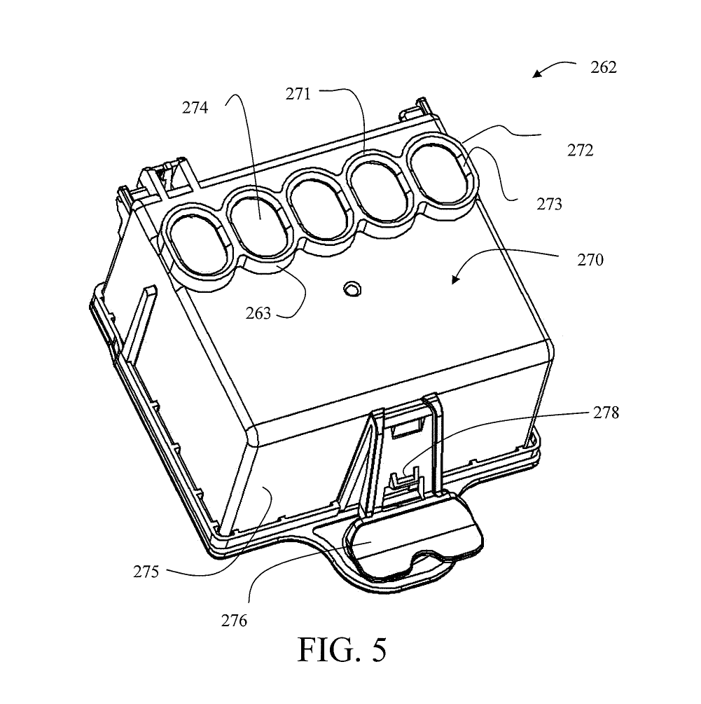

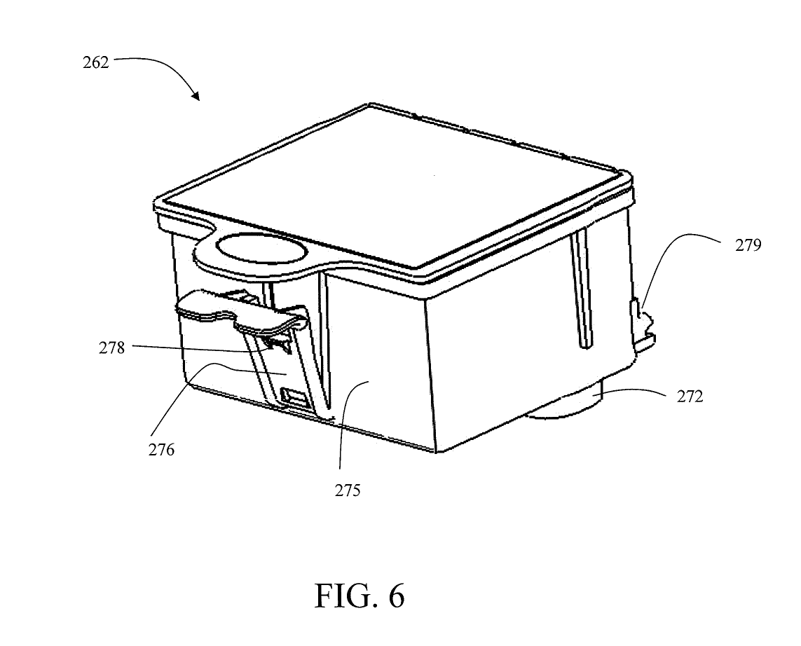

FIG. 5 shows a bottom perspective and FIG. 6 shows a top perspective of detachably mountable multi-chamber ink tank 262. Five outlet ports 272 (each corresponding to an ink source) extend from a bottom surface of a tank body 270 of multi-chamber ink tank 262. Each outlet port 272 has an outlet opening 273, which is oval-shaped in the example of FIG. 5. A raised rim 263 surrounds each outlet opening 273 and the raised rim 263 includes a sealing face 271. A wick 274 is disposed at each outlet opening 273 for transferring of ink to the corresponding inlet port of printhead 250. Wick 274 is a porous member that can be made of a fibrous material (such as a felted material) or a sintered material (such as a sintered plastic) in various embodiments. A latching lever 276 extends outwardly from a back wall 275 of multi-chamber ink tank 262. Latching lever 276 includes a latch 278 that engages with catch 259 (see FIG. 2) on printhead 250 when multi-chamber ink tank 262 is mounted onto printhead 250. A guide feature 279 is provided on a wall opposite back wall 275 for guiding multi-chamber ink tank 262 into proper position on printhead 250. Single chamber ink tank 264 is similar to multi-chamber ink tank 262, but with only one outlet port 272.

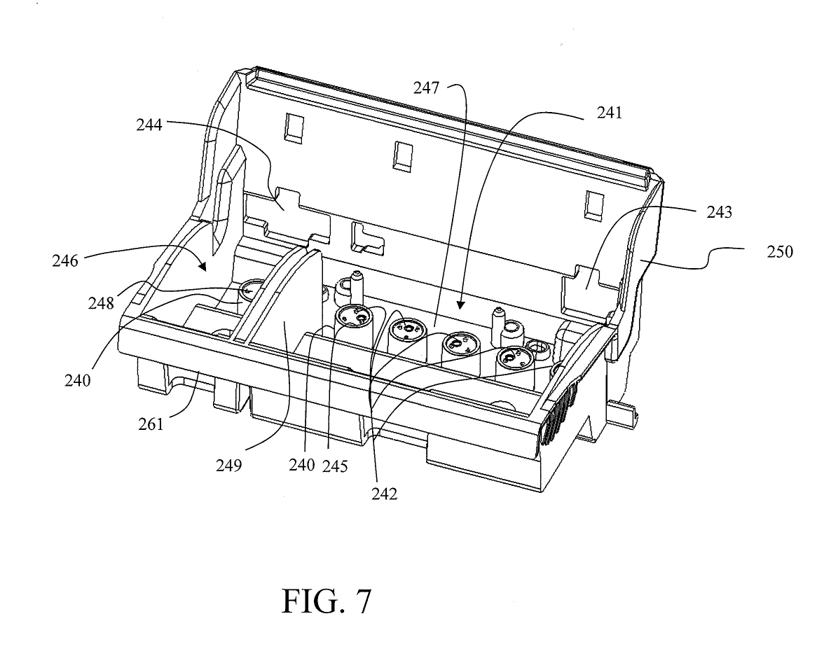

FIG. 7 shows a perspective of printhead 250 without either detachably mountable ink tank 262 or 264 mounted onto it. Multi-chamber ink tank 262 is mountable in a region 241 and single chamber ink tank 264 is mountable in a region 246 of printhead 250. Region 241 is separated from region 246 by a partitioning wall 249, which can also help guide the ink tanks during installation. Guide feature 279 of multi-chamber ink tank 262 is inserted into a hole 243 of printhead 250 during mounting of the multi-chamber ink tank 262. A similar guide feature (not shown) on single chamber ink tank 264 is inserted into hole 244 of printhead 250 during mounting of the single chamber ink tank 264. Five inlet ports 242 are shown in region 241 that connect with ink outlet ports 272 of multi-chamber ink tank 262 when it is installed onto printhead 250, and one inlet port 248 is shown in region 246 for the ink tank port on the single chamber ink tank 264. In the example of FIG. 7 the each inlet port 242 or 248 has the form of a standpipe 240 that extends from the floor of printhead 250. Typically a filter (such as woven or mesh wire filter, not shown) covers an end 245 of the standpipe 240. The diameter of end 245 of standpipe 240 is smaller than that of the outlet openings 273 of ink tank 262 or 264, so that the end 245 of each standpipe 240 is pressed into contact with a corresponding wick 274. When an ink tank 262 or 264 is installed onto the printhead 250, it is in fluid communication with the printhead because of the connection of the wicks 274 at outlet ports 272 with the ends 245 of standpipes 240 of inlet ports 242 or 248. Not shown in FIG. 7 is a gasket that is located on floor 247 and surrounds each of the standpipes 240. When an ink tank is installed onto the printhead 250, sealing face 271 (FIG. 5) of each outlet port 272 seals against the gasket on floor 247 to inhibit ink from leaking out and air from leaking into the ink passageways.

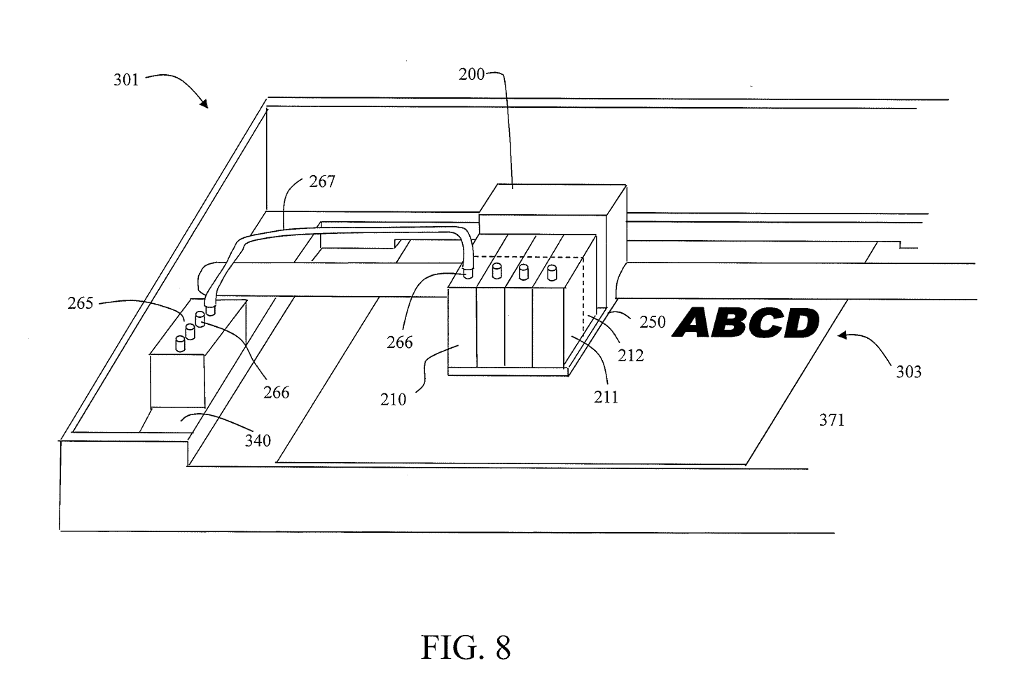

FIG. 8 is a perspective (not to scale) of a portion of an inkjet printing system 301 according to an embodiment of the present invention. Inkjet printhead 250 can be similar to the example of FIG. 2 including at least one nozzle array 253, as well as a corresponding ink inlet, such as inlet ports 242 and 248 of FIG. 7. The main ink supply 265 is stationarily mounted on the support base 340. the carriage 200 is provided to move the printhead 250 back and forth across the print region 303 so that an image can be printed on the sheet 371 of recording medium 20. At least one pressure-regulated intermediate ink supply 210 is also mounted on carriage 200. In the example of FIG. 8, main ink supply 265 includes four ink supplies, each having a tubing connector 266. Inside main ink supply 265 the tubing connectors 266 can extend substantially to the bottom of main ink supply 265, so that ink can continue to be withdrawn as it is depleted. Alternatively, in other configurations (not shown) tubing connectors 266 can be located near the bottom of main ink supply 265. Four intermediate ink supplies 210, each having a tubing connector 266, are mounted on carriage 200 for supplying ink to printhead 250, so the carriage moves the intermediate ink supplies 210 as well as the printhead 250. As ink is used during printing and maintenance processes, ink is replenished into the intermediate ink supplies 210 by main ink supply 265 through flexible tubing 267 (also called a flexible ink supply line herein). It is noted for clarity that only one piece of the flexible tubing 267 is shown in FIG. 8 so as not to obscure other features. Each intermediate ink supply 210 includes a free ink reservoir 211 which includes the corresponding tubing connector 266. Adjacent the free ink reservoir 211 is a regulator chamber 212 for regulating the ink pressure and in particular for damping out pressure spikes that occur as the flexible tubing 267 is moved back and forth by carriage 200.

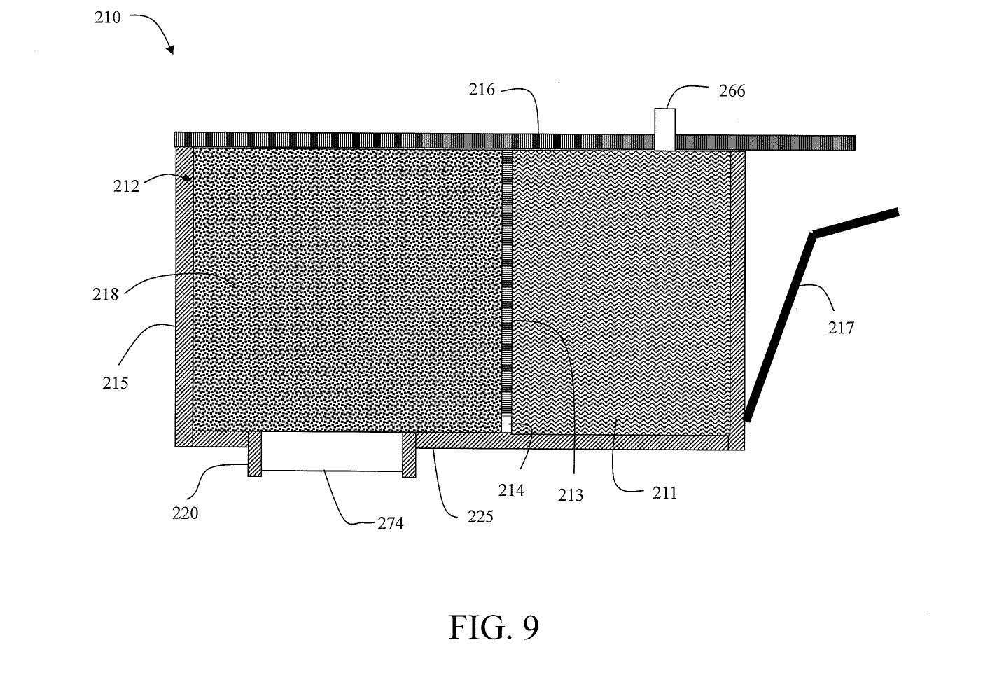

Pressure regulated intermediate ink supply 210 can be integrated as part of printhead 250 or it can be detachable from printhead 250, similar to multi-chamber ink tank 262 and single chamber ink tank 264 described above relative to FIGS. 3, 5 and 6. FIG. 9 shows a cut-away side view of an example of a detachably mountable pressure-regulated intermediate ink supply 210. Intermediate ink supply 210 includes a body 215 having a plurality of walls. The interior surfaces of the walls of body 215 form boundaries for a free ink reservoir 211 and a regulator chamber 212. Regulator chamber 212 includes a capillary medium 218 typically made of felt or foam. In the example shown in FIG. 9, capillary medium 218 substantially fills regulator chamber 212. A dividing wall 213 separates free ink reservoir 211 from regulator chamber 212. An ink passageway 214, such as a hole in dividing wall 213, is provided between free ink reservoir 211 and regulator chamber 212. Regulator chamber includes an ink outlet 220. Ink outlet 220 is similar to outlet port 272 described above with reference to FIG. 5. A wick 274 is provided at ink outlet 220. Wick 274 is in contact with capillary medium 218 for transferring ink from capillary medium 218 to an ink inlet of the printhead 250. In some embodiments, intermediate ink supply 210 can be connected to printhead 250 as described above relative to FIG. 7. In particular, when intermediate ink supply 210 is installed onto printhead 250, it is in fluid communication with the printhead 250 because of the connection of the wick 274 at ink outlet 220 with the end 245 of standpipe 240 of inlet port 242 or 248. In such embodiments, wick 274 is typically directly in contact with a filter (not shown) covering the end of standpipe 240. A latching lever 217 is provided for latching the detachable intermediate ink supply 210 to printhead 250.

A lid 216 is affixed to body 215 and is sealed to both free ink reservoir 211 and regulator chamber 212. Tubing connector 266 passes through lid 216 at free ink reservoir 211 in order to supply ink to free ink reservoir 211 as ink is used during printing or maintenance, as described above relative to FIG. 8. In particular, with reference to FIGS. 8-9, as ink is transferred out of regulator chamber 212 through ink outlet 220, a negative pressure is provided in capillary medium 218, causing ink to be drawn from free ink reservoir 211 through ink passageway 214 into capillary medium 218. Negative pressure then draws ink from main ink supply 265 through flexible tubing 267 and tubing connectors 266 to replenish free ink reservoir 211. Because capillary medium 218 is located between tubing connector 266 and ink outlet 220, it is able to damp out pressure spikes that are due to movement of flexible tubing 267 as the carriage is moved back and forth before the ink reaches the printhead. Ink passageway 214 is typically located closer to ink outlet 220 than it is to lid 216.

In the example of FIG. 9, ink outlet 220 is disposed on a first wall 225 of body 215. Lid 216 forms a second wall opposite first wall 225. With reference also to FIG. 8, flexible tubing 267 that serves as an ink supply line is connected to tubing connector 266 at the lid 216, i.e. at a second wall opposite first wall 225.

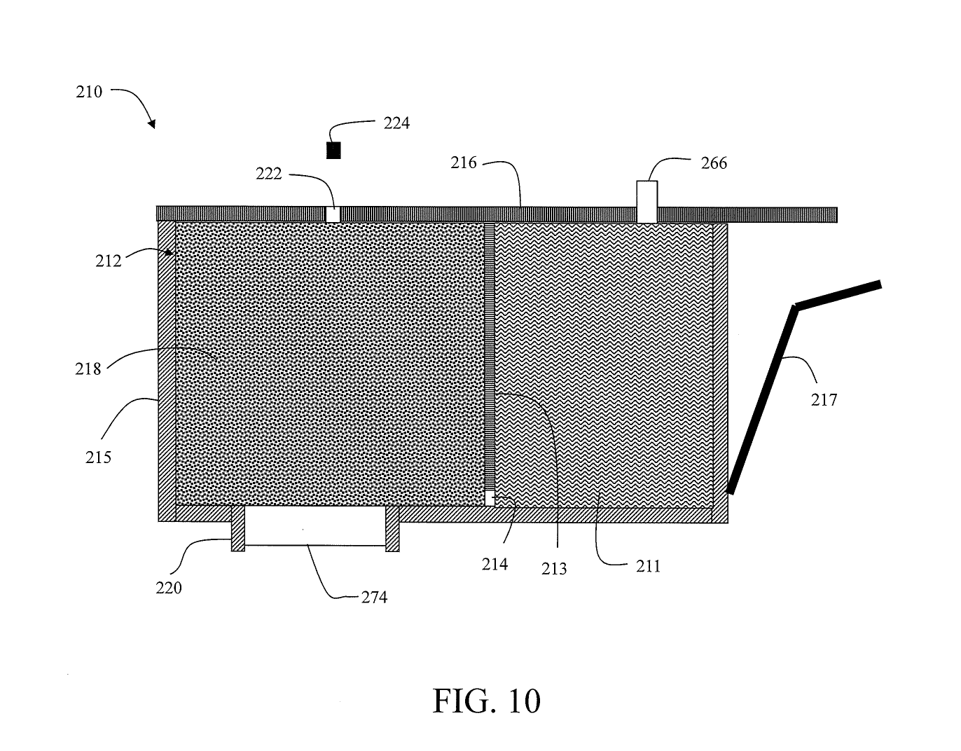

Intermediate ink supply 210 (with its capillary media 218 disposed in a regulator chamber 212 separated by a free ink reservoir 211 by a dividing wall 213 having an ink passageway 214) has a strong resemblance to a typical so-called bubbler ink tank. Bubbler tanks are widely used as detachable ink tanks that are not connected to stationarily mounted off-axis ink supplies. An important distinction between intermediate ink supply 210 and the bubbler tank is that the regulator chamber of a bubbler tank is typically vented to atmosphere. By contrast, the regulator chamber 212 of intermediate ink supply 210 is unvented. In some embodiments, as shown in FIG. 10, a vent 222 is initially provided in lid 216 above regulator chamber 212. However, after initial filling of intermediate ink supply 210 with ink in the factory, a plug 224 is inserted into vent 222 to seal it up, so that when intermediate ink supply 210 is installed in printer system 301 (FIG. 8), regulator chamber 212 is unvented.

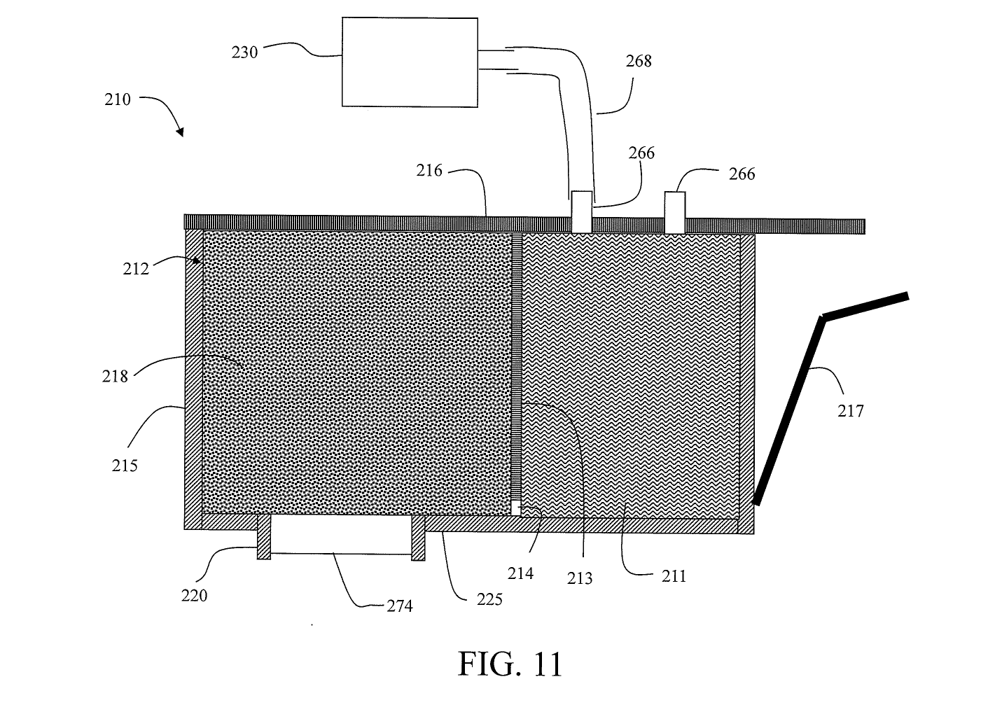

In some embodiments, a second tubing connector 266 is provided on intermediate ink supply 210 at free ink reservoir 211 as shown in FIG. 11 (not to scale). Flexible tubing 268 is connected between the second tubing connector 266 and a suction pump 230 and serves as an air removal line. In that way, if air accumulates in free ink chamber 211, it can periodically be suctioned out by suction pump 230. Since lid 216 is a second wall opposite first wall 225, as described above relative to FIG. 9, the flexible air removal line is connected to the free ink reservoir 211 at a second wall opposite first wall 225 on which the ink outlet 220 is located.

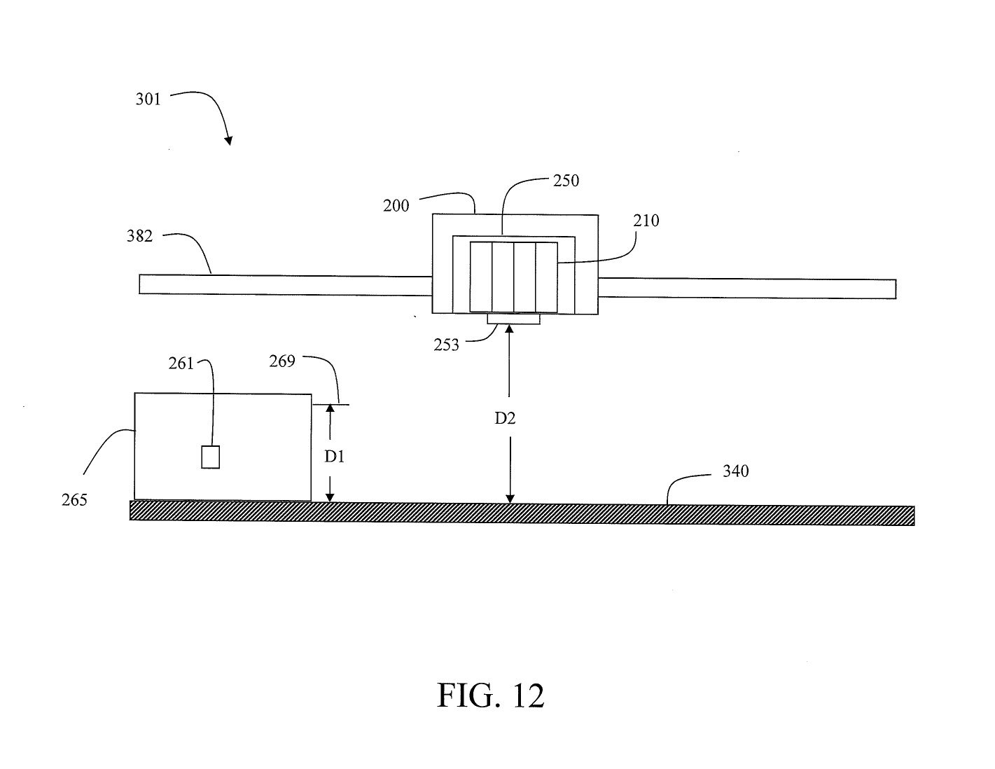

FIG. 12 is a schematic front view of a portion of printing system 301 according to an embodiment of the present invention. Main ink supply 265 is mounted on support base 340. Main ink supply 265 includes an upper fill level 269 located at a first distance D1 from support base 340. Carriage 200 moves printhead 250 and intermediate ink supplies 210 back and forth along carriage guide rod 382. Printhead 250 includes at least one nozzle array 253 located at a second distance D2 from support base 340, where D2 is greater than D1. Flexible tubing connecting main ink supply 265 and intermediate ink supplies 210 are not shown in FIG. 12, so as not to obscure other details. It has been found for such an intermediate ink supply 210 with an unvented regulator chamber 212 that ink pressure at printhead 250 is not as sensitive to the height difference between nozzle array 253 and the ink level in main ink supply 265 as an intermediate ink supply (not shown) having a vented regulator chamber, such that ink is transferred directly into the capillary medium by a needle, for example. Thus, embodiments of the present invention provide more uniform pressure as ink is used from main ink supply 265, and also provide greater freedom for the location of nozzle array 253 relative to main ink supply 265.

Main ink supply 265 can provide enough ink to print on the order of a thousand pages or more, but eventually it will need to be replaced when it is depleted. An ink usage monitoring device 261 is typically provided on main ink supply 265 in order to indicate when main ink supply 265 needs replacing. Ink usage monitoring device 261 can be an ink level detector that detects a level of ink optically, electrically, magnetically, fluidically or by some other direct way. Alternatively, ink usage monitoring device 261 can include an electronic device that stores data corresponding to an initial volume of ink and subtracts amounts of ink as drops are printed or as ink is used in maintenance operations.

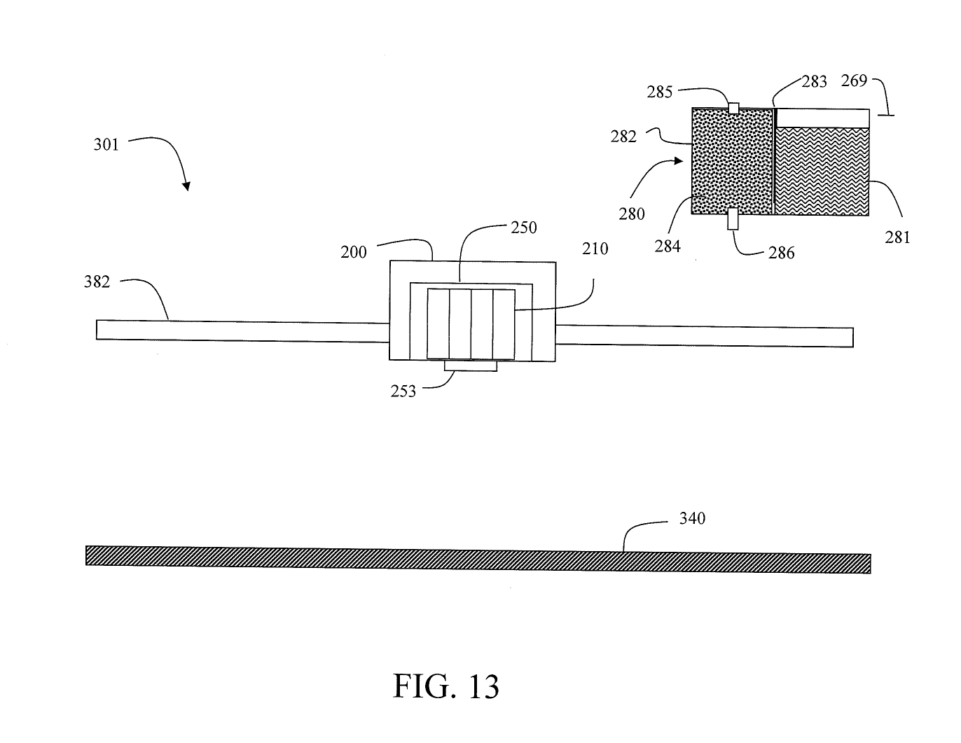

In embodiments described above, the main ink supply 265 has not included a pressure regulator. For such configurations, it is important for the upper fill level 269 of the main ink supply 265 to be positioned at a lower height than nozzle array 253, as described above with reference to FIG. 12, so that a proper amount of negative pressure will be provided at the printhead. For configurations where a pressure regulated main ink supply 280 includes a pressure regulator to provide a level of negative pressure (note main ink supply 280 is similar to main ink supply 265 except it includes a regulator), the upper fill level 269 of pressure regulated main ink supply 280 can be positioned at a higher height than nozzle array 253, as shown in the schematic front view of FIG. 13. In particular, the pressure regulated main ink supply 280 in the example of FIG. 13 includes a free ink chamber 281 and a capillary chamber 282 separated by a dividing wall 283. Capillary chamber 282 includes a capillary medium 284. However, unlike the regulator chamber 212 of intermediate ink supply 210, capillary chamber 282 of pressure regulated main ink supply 280 includes a vent 285. This permits air to enter to accommodate pressure changes in the pressure regulated main ink supply 280 as ink is transferred to intermediate ink supply 210 through outlet 286 via flexible tubing (not shown).

The invention has been described in detail with particular reference to certain preferred embodiments thereof, but it will be understood that variations and modifications can be effected within the spirit and scope of the invention.

### PARTS LIST

10 Inkjet printer system
12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzle(s)
122 Ink delivery pathway (for first nozzle array)
130 Second nozzle array
131 Nozzle(s)
132 Ink delivery pathway (for second nozzle array)
181 Droplet(s) (ejected from first nozzle array)
182 Droplet(s) (ejected from second nozzle array)
200 Carriage
210 Intermediate ink supply
211 Free ink reservoir
212 Regulator chamber
213 Dividing wall
214 Ink passageway
215 Body
216 Lid
217 Latching lever
218 Capillary media
220 Ink outlet
222 Vent
225 First wall
230 Suction pump
240 Standpipe
241 Region (for mounting multi-chamber ink reservoir)
242 Inlet port
243 Hole
244 Hole
245 End
246 Region (for mounting single chamber ink reservoir)
247 Floor
248 Inlet port
249 Partitioning wall
250 Printhead
251 Printhead die
253 Nozzle array
254 Nozzle array direction
256 Encapsulant
257 Flex circuit
258 Connector board
259 Catch for ink tank latching mechanism
261 Ink usage monitoring device
262 Multi-chamber ink tank
263 Rim
264 Single-chamber ink tank
265 Main ink supply
266 Tubing connector
267 Flexible tubing (ink supply line)
268 Flexible tubing (air removal line)
269 Upper fill level
270 Tank body
271 Sealing face
272 Outlet port
273 Outlet opening
274 Wick
275 Back wall
276 Latching lever
278 Latch
279 Guide feature
280 Pressure regulated main ink supply
281 Free ink chamber
282 Capillary chamber
283 Capillary medium
284 Dividing wall
285 Vent
286 Outlet
300 Printer chassis
301 Printing system
302 Paper load entry direction
303 Print region
304 Media advance direction
305 Carriage scan direction
306 Right side of printer chassis
307 Left side of printer chassis
308 Front of printer chassis
309 Rear of printer chassis
310 Hole (for paper advance motor drive gear)
311 Feed roller gear
312 Feed roller
313 Forward rotation direction (of feed roller)
320 Pick-up roller
322 Turn roller
323 Idler roller
324 Discharge roller
325 Star wheel(s)
330 Maintenance station
340 Support base
370 Stack of media
371 Sheet
380 Carriage motor
382 Carriage guide rail
383 Encoder fence
384 Belt
390 Printer electronics board
392 Cable connectors

1. An inkjet printing system comprising:
an inkjet printhead including a nozzle array and an ink inlet fluidically connected to the nozzle array;
a pressure regulated ink supply including:
an unvented regulator chamber including:
a capillary medium; and
an ink outlet connected to the ink inlet of the printhead;
a free ink reservoir including an ink inlet connector; and
a dividing wall disposed between the regulator chamber and the free ink reservoir, the dividing wall including an ink passageway permitting ink to pass from the free ink reservoir into the regulator chamber;
a carriage configured to move the printhead and the pressure regulated ink supply back and forth across a print region;
a stationarily mounted main ink supply; and
a flexible ink supply line connecting the main ink supply to the ink inlet connector of the free ink reservoir.

2. The inkjet printing system of claim 1 further comprising:
a suction pump; and
a flexible air removal line connected between the suction pump and the free ink reservoir.

3. The inkjet printing system of claim 2, the ink outlet of the pressure regulated ink supply being disposed on a first wall, wherein the flexible air removal line is connected to the free ink reservoir at a second wall opposite the first wall.

4. The inkjet printing system of claim 1, the ink outlet of the pressure regulated ink supply being disposed on a first wall, wherein the flexible ink supply line is connected to the free ink reservoir at a second wall opposite the first wall.

5. The inkjet printing system of claim 1, the printhead further including a filter disposed at the ink inlet.

6. The inkjet printing system of claim 5, further comprising a wick being disposed at the ink outlet of the regulator chamber, wherein the wick is directly in contact with the filter.

7. The inkjet printing system of claim 1, wherein the capillary medium substantially fills the regulator chamber.

8. The inkjet printing system of claim 1, wherein the capillary medium comprises felt.

9. The inkjet printing system of claim 1, wherein the capillary medium comprises foam.

10. The inkjet printing system of claim 1, wherein the pressure regulated ink supply is detachable from the printhead.

11. The inkjet printing system of claim 1 further comprising a support base, the main ink supply including an upper ink fill level disposed at a first distance from the support base, wherein the nozzle array is disposed at a second distance from the support base, the second distance being greater than the first distance.

12. The inkjet printing system of claim 1, the main ink supply including a pressure regulator.

13. The inkjet printing system of claim 12, the pressure regulator of the main ink supply including a vented capillary chamber.

14. The inkjet printing system of claim 1, the main ink supply including an ink usage monitoring device.

15. The inkjet printing system of claim 1, wherein the ink passageway in the dividing wall is disposed proximate the ink outlet of the regulator chamber.
